(19) United States
(12) Patent Application Publication
(10) Pub. No.: US 2002/0184372 A1
(43) Pub. Date: Dec. 5, 2002

(54) Application managing apparatus

(75) Inventors: Akira Ishikawa, Kawasaki-shi (JP); Naoto Yamaguchi, Ichikawa-shi (JP)

Correspondence Address: GREENBLUM & BERNSTEIN, P.L.C., 1941 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/156,033

(22) Filed: May 29, 2002

(30) Foreign Application Priority Data
May 29, 2001 (JP) 2001-160802

(51) Int. Cl. G06F 15/173; G06F 15/16

(52) U.S. Cl. 709/227; 709/226

(57) ABSTRACT

An application managing apparatus that manages start-up and install of applications is provided with connection receiving section 11 that receives a connection request for an application with the designated address, address/application-location managing section 13 that manages the correspondence between an address of an application and substantial location of the program, application state obtaining section 14 that obtains a current state of an application requested for the connection, resource information obtaining section 17 that obtains a currently usable resource amount, and application stop determining section 16 that determines an application to stop so as to reserve a resource amount needed for starting a new application. The apparatus keeps resident applications started as many as the resources permit, and when the resources are not sufficient in starting a new application, determines an application to stop based on a determining algorithm.

### BACKGROUND OF THE INVENTION

1. Field of the Invention

The present invention relates to an application managing apparatus that manages start-up of an application program in an apparatus with poor resources (storage device such as a memory and HDD, and power of CPU) such as a network home electrical appliance, and more particularly to achieving application management with reduced resource consumption.

2. Description of the Related Art

In recent years, developments have been proceeded fast in intelligent home electrical appliances such as network-connected home appliances, AV apparatuses and STB (Set-Top Box). These apparatuses, so-called network home appliances, information home appliances or the like, are generally poor in resources. Since installing a memory or the like may solve the problem but increases the cost of the apparatus, expanding the hardware is not likely in practical use. Therefore, it has been required to increase the resource efficiency to compensate for the lack of resources.

Conventionally, as a method for efficiently utilizing resources of a computer, there is known a method for reducing a memory use amount of a memory-resident daemon program group. The daemon program is resident in a system, receives a request from a user, and automatically executes system control that the user should not execute directly. In the case of a system with a resident daemon program group, since a large memory use amount is required, the system is constructed so that only a daemon program called “Inetd” is started and maintains its accept state as a representative one of the daemon program group, and that “Inetd” starts up the other daemon programs only when each of the programs is executed.

FIG. 1 shows the operation of Inetd. Inetd awaits an access request from a client program,

(1) receives the access request when the client program instructs the access request to a particular port;

(2) searches a set file prescribing service names, port numbers and protocol types for an application of the designated port;

(3) obtains a location of a program of the searched application from a set file prescribing service names, program locations and start-up options;

(4) starts up the program at the obtained location;

(5) connects a network socket connected to the client to standard input/output of the program, where an application program is executed only when connected to the standard input/output; and

(6) finishes the program when finishing the operation requested from the client.

In this way, in the case where daemon programs except Inetd are started up only when executed, it is possible to save a memory consumption amount as compared to the case where all the daemon programs are memory-resident in their accept state.

However, in the conventional method, since the daemon program is finished when the operation is finished to save the memory consumption, it is required to repeat the processing of above items (2) to (5) whenever the client makes a request, resulting in a problem that the overhead (time that is not used directly for the target work) is large.

### SUMMARY OF THE INVENTION

It is an object of the present invention to provide an application managing apparatus that reduces the resource consumption of an apparatus, suppresses increases in the overhead, and efficiently manages the start-up of applications.

In order to achieve the object, the application managing apparatus of the present invention keeps memory-resident applications started as many as the resources permit, and determines an application to stop based on a determination algorithm when the resources are not sufficient in starting up a new application. Further, an application is installed corresponding to a request, instead of all the applications with a possibility of receiving a connection request being installed in advance. Therefore, it is possible to execute efficient application start-up management and install management with the resource consumption of terminal apparatuses and increases in the overhead both suppressed.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a diagram showing a method of saving resources in a conventional resident daemon program;

FIG. 2 is a block diagram showing a configuration of an application managing apparatus in Embodiment 1;

FIG. 3 is a flow diagram showing the operation of the application managing apparatus in Embodiment 1;

FIG. 4 shows an example of application log data in Embodiment 1;

FIG. 5 shows another example of application log data in Embodiment 1;

FIG. 6 is a block diagram showing a configuration of an application managing apparatus in Embodiment 2;

FIG. 7 is a flow diagram showing the operation of the application managing apparatus in Embodiment 2;

FIG. 8 shows an example of application log data in Embodiment 2;

FIG. 9 is a block diagram showing a configuration of an application managing system in Embodiment 3;

FIG. 10 is a flow diagram showing the operation of the application managing system in Embodiment 3;

FIG. 11 is a block diagram showing a configuration of an application managing system in Embodiment 4; and

FIG. 12 is a block diagram showing a configuration of an application managing system in Embodiment 5.

### DETAILED DESCRIPTION OF THE PREFERRED EMBODIMENTS

Embodiments of the present invention will be described below with reference to accompanying drawings.

(Embodiment 1)

Embodiment 1 explains an application managing apparatus that manages start-up of resident application programs.

The application managing apparatus permits each of resident applications to maintain its started state when the resources are sufficiently left. Therefore, when an application requested from a client program is already started and in its accept state, the application is immediately executed. Further, when an application requested from a client program is not started and needs to be newly started, in order to reserve a resource amount needed for the execution of the application, the managing apparatus stops a started application when necessary.

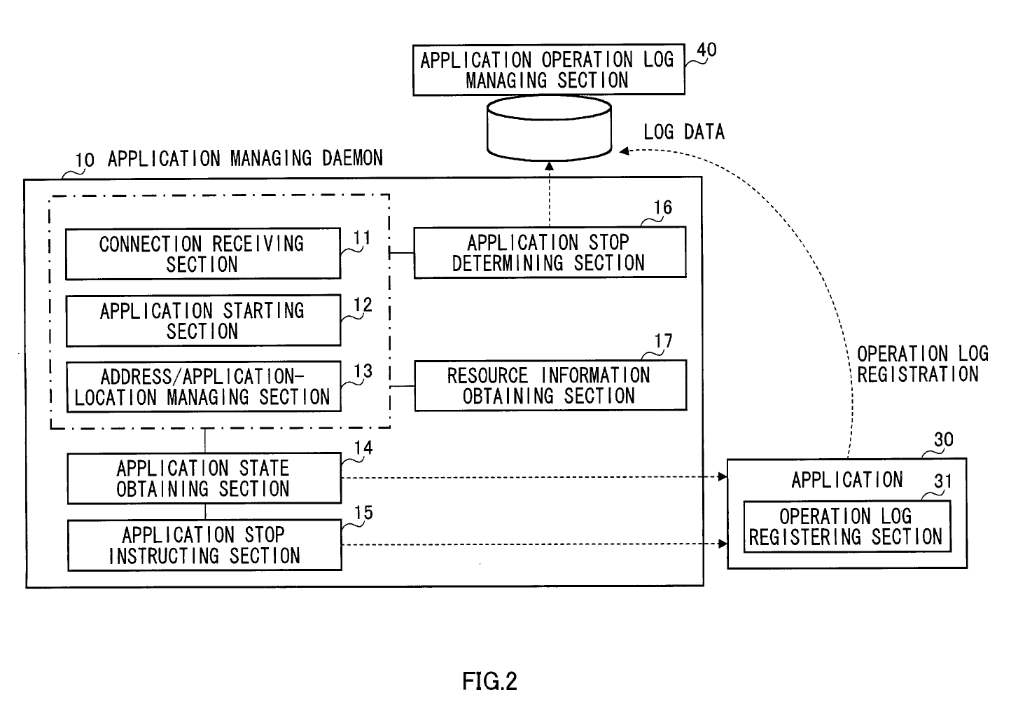

As shown in FIG. 2, the apparatus is provided with application managing daemon 10 that manages the start-up of application 30, and application operation log managing section 40 that manages state changes in application 30. Application 30 is provided with operation log registering section 31 that registers state changes in application 30 with application operation log managing section 40, and outputs log data indication of a state change of application 30 when being in its accept state.

Application managing daemon 10 is provided with connection receiving section 11 that receives a connection request for an application requested from a client program with an address specified, address/application-location managing section 13 that manages the correspondence between an address of an application and substantial location of the program while searching for information to start the application using the address specified in the connection request, application starting section 12 that starts the application based on the location information of the application obtained from address/application-location managing section 13, application state obtaining section 14 that obtains a current state of application 30 requested for the connection, resource information obtaining section 17 that obtains information on currently usable resource amount, application stop determining section 16 that judges whether or not it is possible to execute the application requested for the connection from the information obtained in resource information obtaining section 17, and when judging it is impossible, determines an application to stop, and application stop instructing section 15 that instructs application 30 targeted for the stop determined in application stop determining section 16 to stop operating.

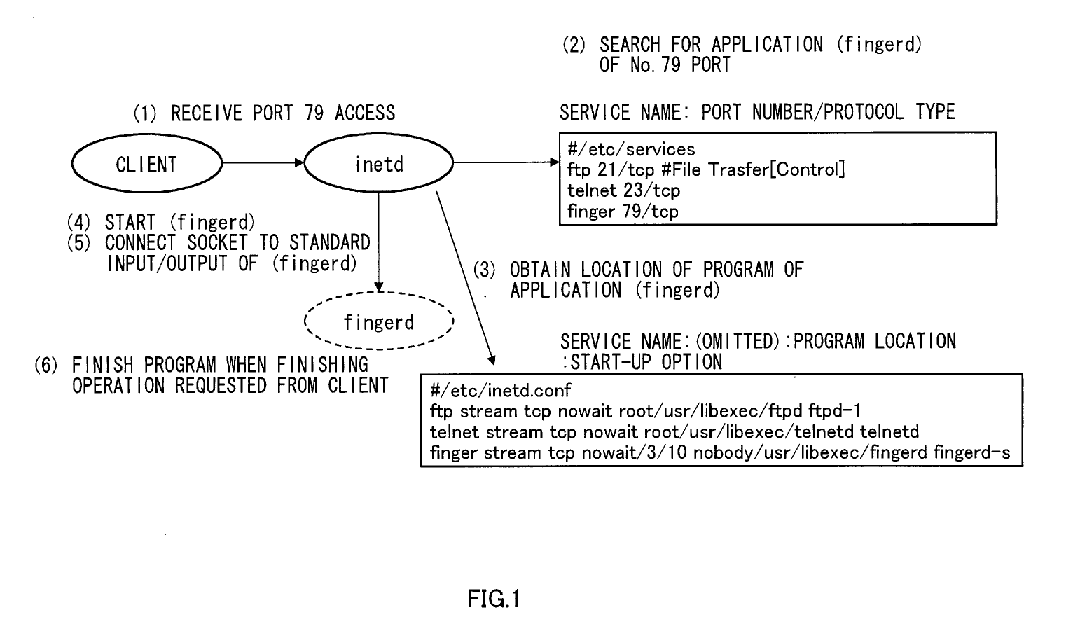

In addition, an apparatus that performs a conventional method (FIG. 1) also has connection receiving section 11, address/application-location managing section 13 and application starting section 12.

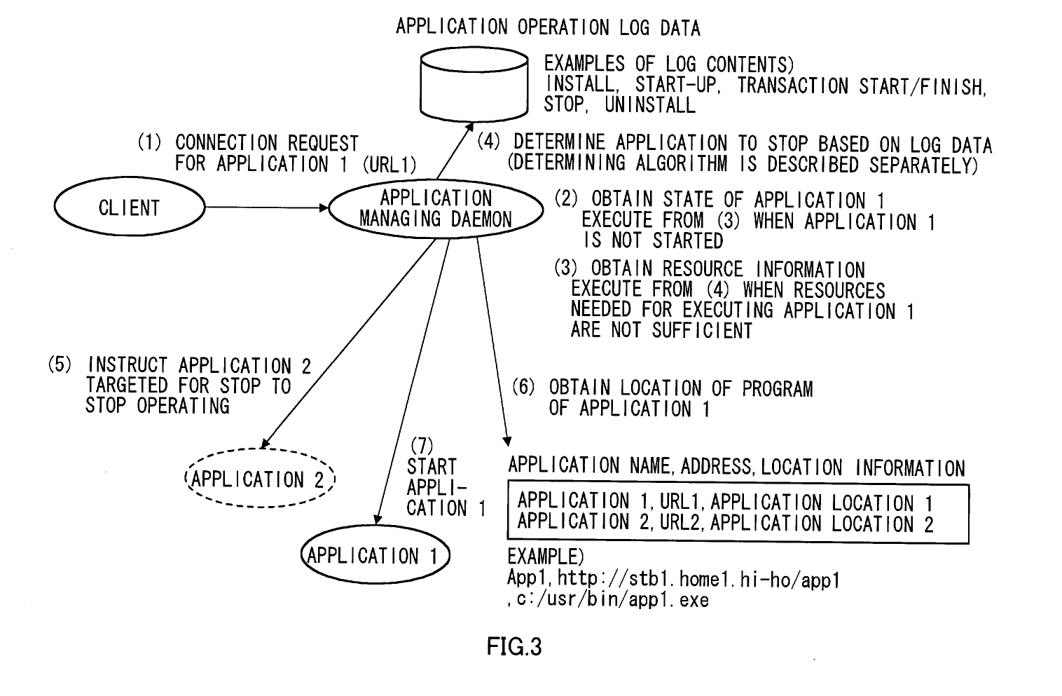

FIG. 3 shows the operation flow of the apparatus of this embodiment.

(1) The client program makes a connection request for application 1 while designating URL1, and connection receiving section 11 in application managing daemon 10 receives the connection request.

(2) Application state obtaining section 14 determines whether application 1 is one that is already started. When application 1 is already started, application managing daemon 10 finishes its start-up managing operation. When application 1 is not started,

(3) resource information obtaining section 17 obtains a currently usable resource amount. Application stop determining section 16 determines whether the resource amount permits the execution of application 1. When it is not possible,

(4) application stop determining section 16 determines application to stop based on application log data managed in application operation log managing section 40.

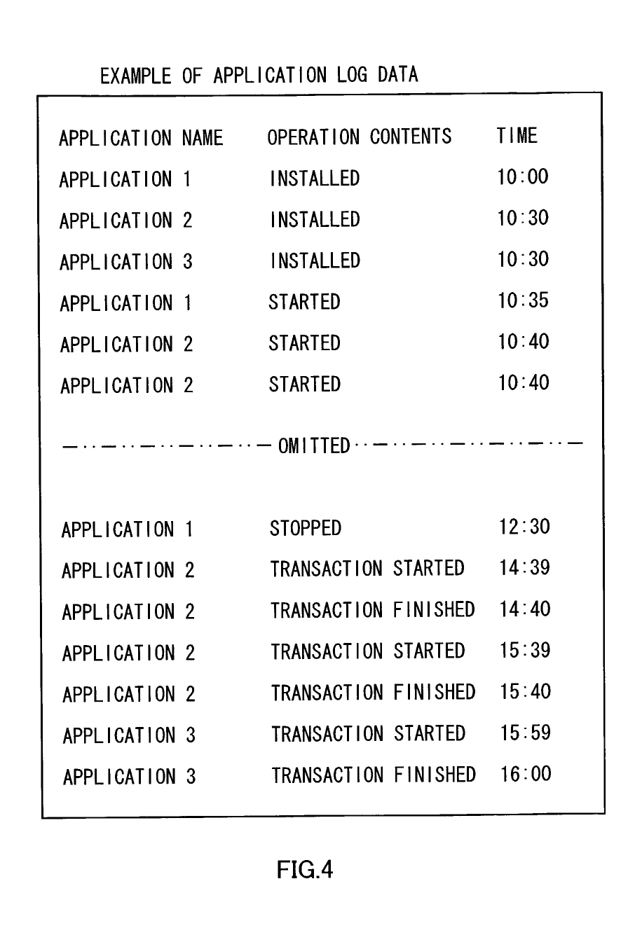

Application operation log managing section 40 manages, for example, as shown in FIG. 4, log data such as application names, operation contents and times. As a determining algorithm, for example, application stop determining section 16 determines an application with the earliest finished transaction among transactions lately performed to be an application to stop. In this case, application 2 is one targeted for the stop.

(5) Application stop instructing section 15 instructs application 2 targeted for the stop to stop operating.

(6) Address/application-location managing section 13 manages a table describing the correspondence between an application name, address and location of substantial program (location information), and searches the table for location information corresponding to application 1/URL1 requested for the connection.

(7) Application starting section 12 starts application 1 at the location searched by address/application-location managing section 13.

In addition, in item (3), when the currently usable resource amount permits the execution of application 1, processing of items (6) and (6) is performed following item (3).

In this way, the application managing apparatus stops a started application only in the case where resources needed for starting a new application cannot be reserved, without stopping started applications in cases except the above. Therefore, a probability becomes high that an application requested from a client program is already started, and it is thereby possible to generally decrease the overhead in start-up.

In addition, application stop determining section 16 may determine an application to stop based on such a determining algorithm that stops an application with the least number of times a client program requests for its processing. In this case, application 3 is selected as one to stop from the application log data in FIG. 4.

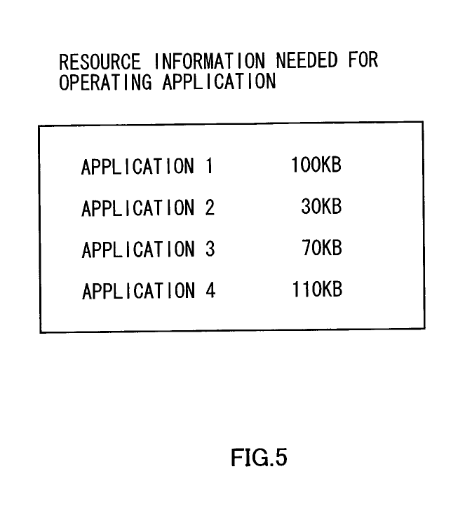

It may be possible that, as shown in FIG. 5, resource information needed for the operation of each application is added to the application log data managed in application operation log managing section 40, and that application stop determining section 16 selects an application to stop based on an algorithm, as a determining algorithm that determines an application to stop, which selects a combination of applications that minimizes the number of applications to stop so as to reserve the resource amount needed for staring a new application. In this case, on the assumption that a resource capacity of 100 KB needs to be reserved to execute application 1, application 4 is selected to be stopped from FIG. 5.

Using such a determining algorithm decreases the number of applications to be stopped. In other words, it is possible to keep more applications of accept state, and to increase a probability that an application requested from a client program is already started and maintains its accept state. The operation of the application managing apparatus explained in this embodiment is executed specifically when STB provided with the function of broadcast reception and/or internet connection receives a content distribution service from a server on the internet based on a request from a client, for example.

When receiving a content distribution service, following procedures are required:

(1) apply for the content distribution service;

(2) check the existence of receiving software and its version, and when no suitable receiving software exists, download such software;

(3) check a state of the receiving software, and when the software is not started yet, start the software;

(4) check remaining resources, and when resources are not sufficient, stop or uninstall another software; and

(5) start receiving content distribution.

When STB executes the processing of items (3) and (4), an application managing apparatus of STM efficiently starts the receiving software needed to receive a content distribution according to the procedures shown in this embodiment.

(Embodiment 2)

Embodiment 2 explains an application managing apparatus that efficiently performs downloading of an application. This processing corresponds to one in above-mentioned item (2) where a content distribution service is received.

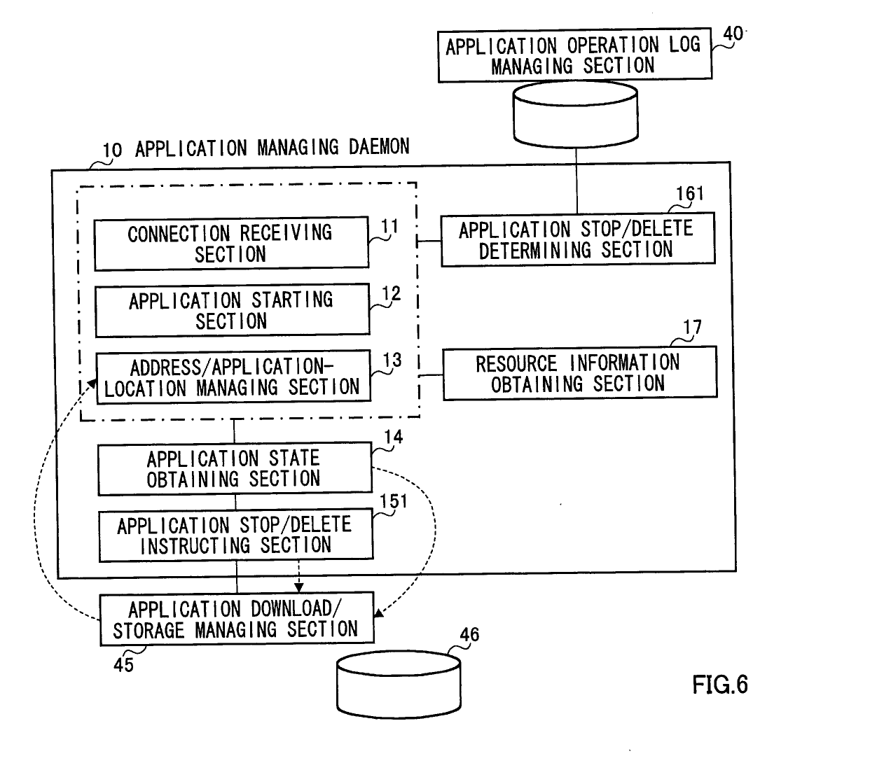

As shown in FIG. 6, the apparatus is provided with connection receiving section 11 that receives a connection request for an application requested from a client program with an address specified, application state obtaining section 14 that determines whether the requested application is installed onto local disk 46, application starting section 12 that starts the requested application, address/application-location managing section 13 that manages the correspondence between an address of an application and application location information and searches for where the application is downloaded using the address specified in the connection request, application download/storage managing section 45 which, when the application requested for the connection is not installed onto local disk 46, obtains downloading source information from address/application-location managing section 13 to download the needed application onto the local disk, resource information obtaining section 17 that determines whether a disk space is sufficient to store the application in downloading the application, application stop/delete determining section 161 that specifies an application to delete (uninstall) from local disk 46 when the space is not sufficient, and application stop/delete instructing section 151 that instructs to delete the application specified to be deleted from the local disk.

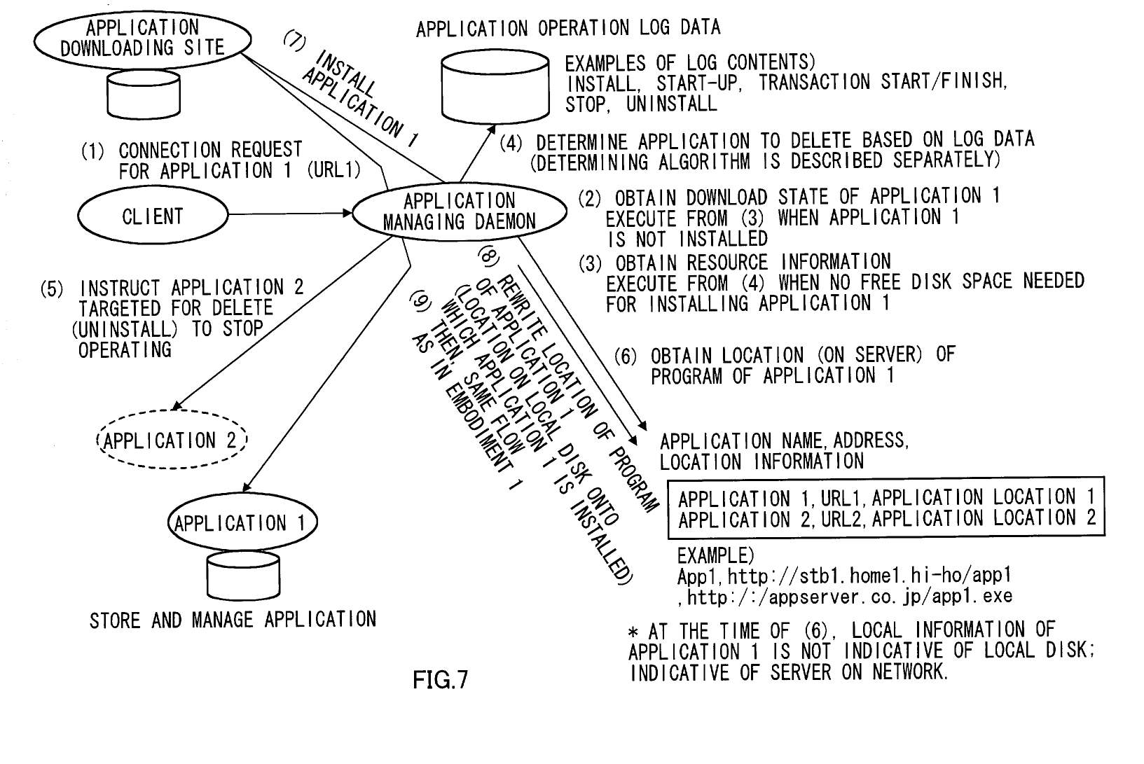

FIG. 7 shows the operation flow of the apparatus.

(1) The client program makes a connection request for application 1 while designating URL1, and connection receiving section 11 in application managing daemon 10 receives the connection request.

(2) Application state obtaining section 14 obtains information of whether application 1 is installed onto local disk 46 from application download/storage managing section 45 that manages storage of applications in local disk 46.

(3) Resource information obtaining section 17 obtains a free disk space of local disk 46 from application download/storage managing section 45. Application stop/delete determining section 161 determines whether the free disk space permits the install of application 1. When not possible,

(4) Application stop/delete determining section 161 determines an application to delete based on the application log data managed in application log managing section 40.

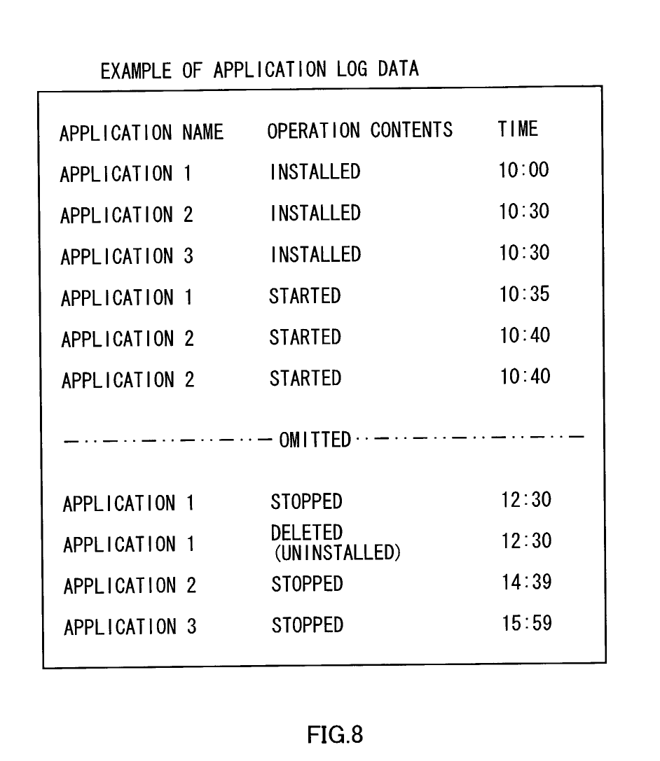

Application operation log managing section 40 manages, for example, as shown in FIG. 8, log data such as application names, operation contents and times. As a determining algorithm, for example, application stop/delete determining section 161 determines an application with the longest stopped time to be an application to delete. In this case, application 2 is one to delete.

(5) Application stop/delete instructing section 151 instructs application download/storage managing section 45 to delete application 2 to be deleted from local disk 46, and the section 45 deletes application 2 from local disk 46.

(6) Address/application-location managing section 13 manages a table describing the correspondence between an application name, address and substantial location of the program (location information), and at this point, the location information of application 1 indicates a server on the network. Application download/storage managing section 45 obtains the location information of application 1 from address/application-location managing section 13, and

(7) installs application 1 from an application downloading site indicated by the location information.

(8) Address/application-location managing section 13 rewrites the location information of a program of application 1 to an installed location on local disk 46.

(9) Then, according to the procedures in Embodiment 1, application 1 is started up.

In addition, in item (2), when application 1 is already installed onto local disk 46, the operation flow proceeds to item (9). Further, in item (3), when a free disk space permitting the install of application 1 exists, the operation flow proceeds to item (6).

In this way, it is possible to save a disk space for storing applications by installing an application corresponding to a request, instead of installing in advance all the applications with a possibility of receiving a connection request.

(Embodiment 3)

Embodiment 3 explains an application managing system in which an application managing server controls remotely an application managing apparatus.

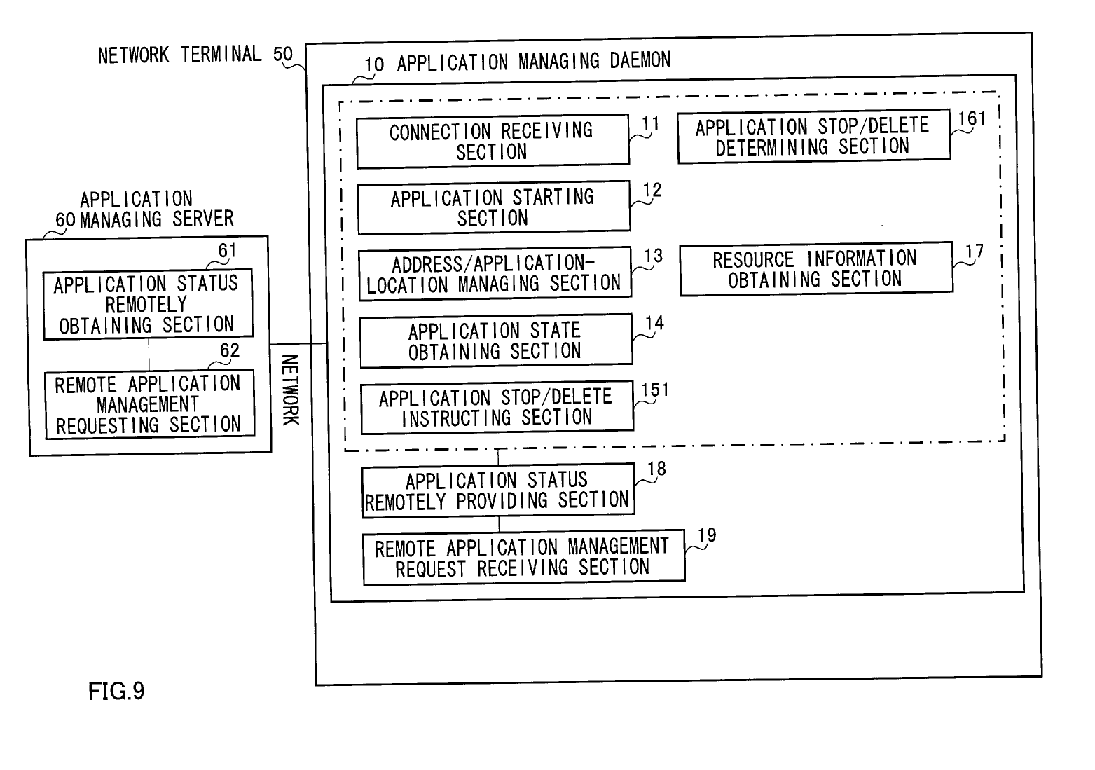

As shown in FIG. 9, the system is composed of network terminal 50 having an application managing apparatus, and application managing server 60 that controls install and start-up of applications in network terminal 50 through a network.

The application managing apparatus in network terminal 50 is provided with, in addition to the configuration (FIG. 6) in Embodiment 2, application status remotely providing section 18 that provides information on install status and start-up/stopped status of an application to application managing server 60 through a network, and remote application management request receiving section 19 that receives an application install request and start-up request from application managing server 60, and according to the request, performs downloading, install and start-up of the application.

Application managing server 60 is provided with application status remotely obtaining section 61 that obtains a status (install status and start-up status) of an application from the application managing apparatus in network terminal 50 through a network, and remote application management requesting section 62 that requests for install or start-up of an application through the network when the application is not installed or started.

For example, application managing server 60 in the system controls the receiving software needed to receive content distribution services to be installed into network terminal 50 or started before a client makes request.

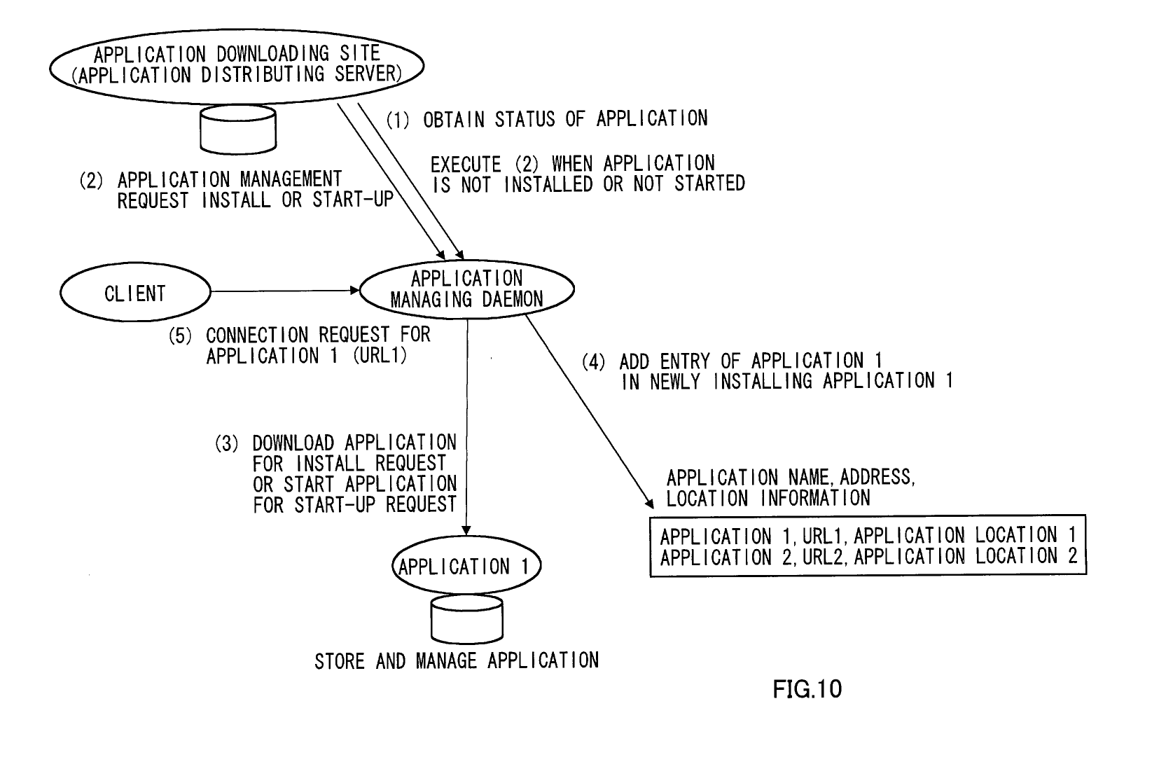

FIG. 10 shows the operation flow in the system.

(1) Application status remotely obtaining section 61 in application managing server 60 obtains an install status and start-up/stopped status of application 1 from application status remotely providing section 18 in the application managing apparatus through the network.

(2) Remote application management requesting section 62 in application managing server 60 requests for install or start-up of application 1 through the network when application 1 is not installed or started, respectively.

(3) In the application managing apparatus, remote application management request receiving section 19 receives the install request or start-up request from application managing server 60. When receiving the install request, the application managing apparatus installs application 1 according to installing procedures explained in Embodiment 2, while starting application 1 according to starting procedures explained in Embodiment 1 when receiving the start-up request.

(4) When application 1 is newly installed, address/application-location managing section 13 adds an entry of application 1 to the managing table.

(5) When the client program makes a connection request for application 1, since application 1 is already installed or started, it is possible to response to the request from the client promptly.

In this way, even when an application is not installed or started in a terminal before a client makes a connection request for the application, the server recognizes the status of the terminal, sets the application for a predetermined state, and enables the client to connect to the application.

(Embodiment 4)

In an application managing system in Embodiment 4, double billing is prevented when an application deleted to reserve resources is re-downloaded.

In a service that bills for the download of an application, when a purchased application is deleted to reserve resources as explained in Embodiment 2, re-downloading the application requires the billing again. The system according to this embodiment prevents occurrences of such billing.

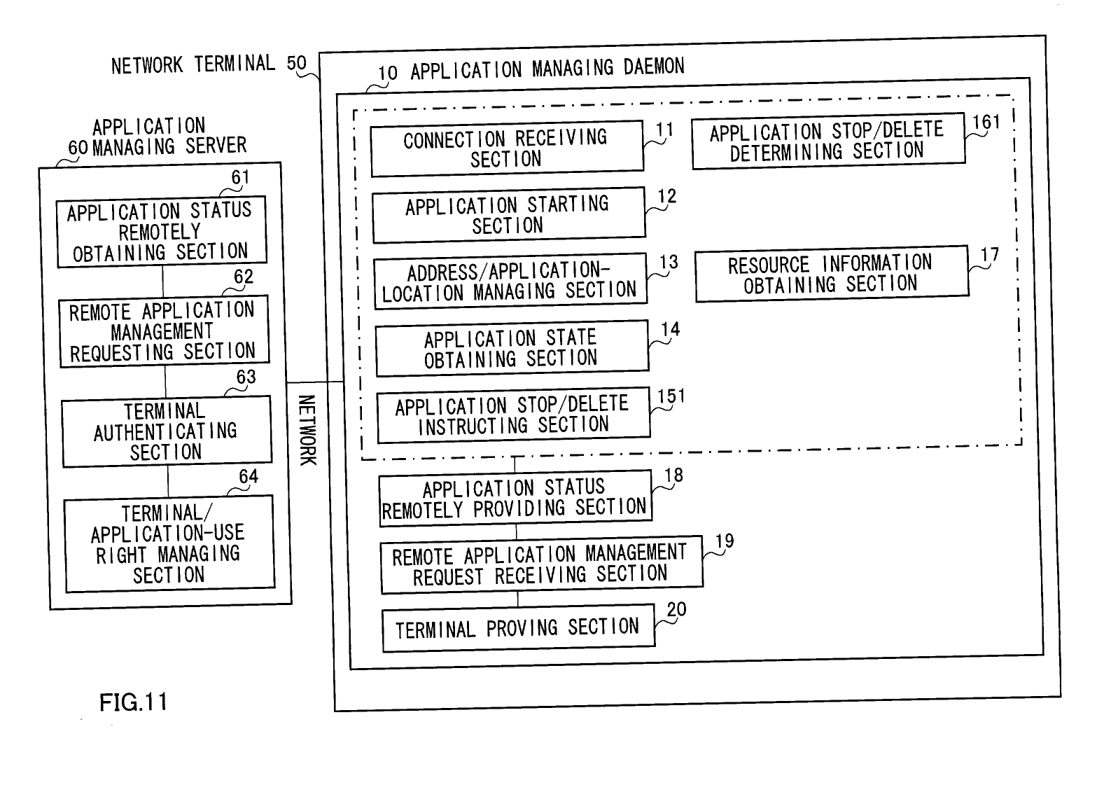

In the system, as shown in FIG. 11, the application managing apparatus in network terminal 50 is provided with terminal proving section 20 that specifies a person in charge of network terminal 50 to prove, and application managing apparatus 60 is provided with terminal authenticating section 63 that authenticates a terminal that downloads an application using terminal proving section 20 in the download of the application, and terminal/application-use right managing section 64 that manages the correspondence between the authenticated terminal and application.

In the system, when network terminal 50 downloads an application from application managing server 60, terminal authenticating section 63 in application managing server 60 authenticates a terminal that downloads an application using terminal proving section 20. Terminal/application-use right managing section 64 in application managing server 60 manages the correspondence between the authenticated terminal and application.

Network terminal 50 may delete purchased application 1 once to reserve resources and then re-download and install application 1 due to a repeated connection request from a client. At this point, terminal authenticating section 63 in application managing server 60 authenticates network terminal 50 using terminal proving section 20 in network terminal 50. Then, terminal/application-use right managing section 64 confirms that authenticated network terminal 50 purchased application 1 previously from managing data, and omits billing for the current downloading.

In this way, the system is capable of preventing an occurrence of double-billing for once purchased application even when a terminal re-downloads and installs the application.

(Embodiment 5)

In an application managing system of Embodiment 5, even when an application to be deleted so as to reserve resources has user data, it is possible for an application managing server to save the user data.

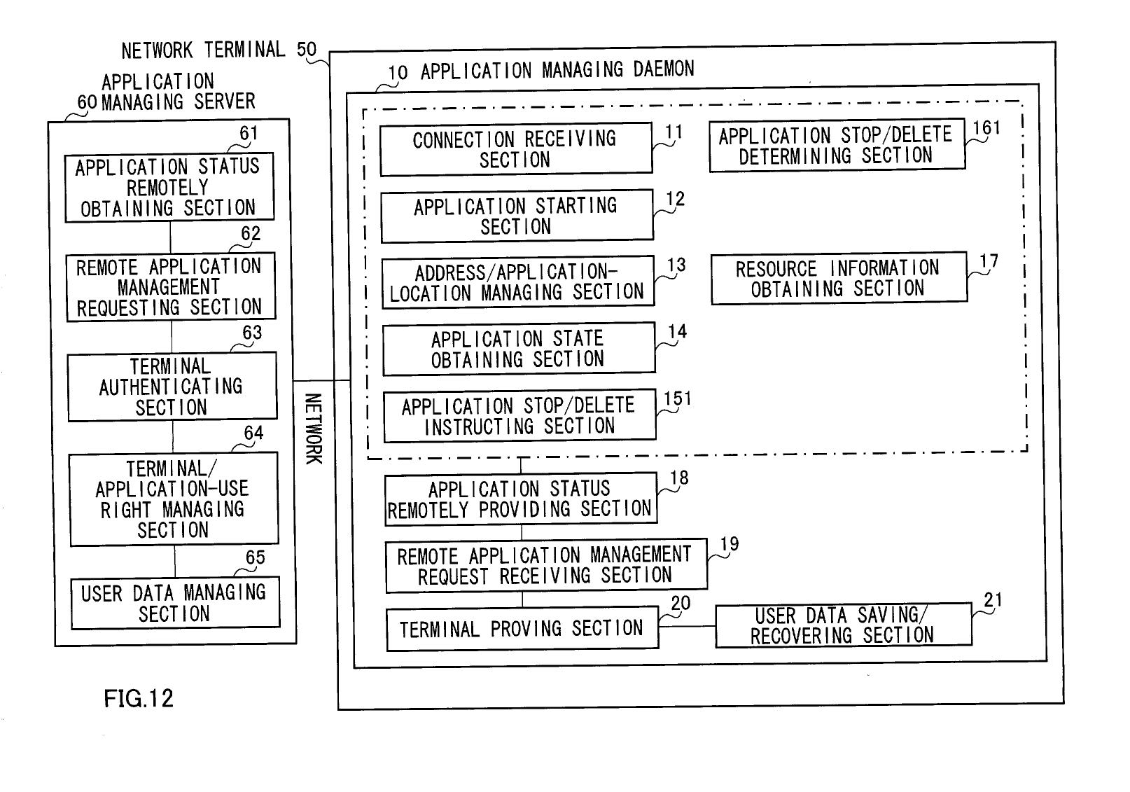

In the system, as shown in FIG. 12, an application managing apparatus in network terminal 50 is provided with user data saving/recovering section 21 that saves user data in application managing server 60 in deleting an application and recovers the user data in re-installing the application, and application managing server 60 is provided with user data managing section 65 that manages the saved user data.

In the system, when an application to be deleted so as to reserve resources has user data such as operation log, preference information and operation data, user data saving/recovering section 21 in network terminal 50 transmits a saving request for user data and further transmits the user data to user data managing section 65 in application managing server 60.

User data managing section 65 stores and manages received user data in response to the saving request for the user data.

User data saving/recovering section 21 in network terminal 50 transmits a recovering request for the user to user data managing section 65 in application managing server 60 in installing again the application.

User data managing section 65 transmits the stored and managed user data to user data saving/recovering section 21 in response to the recovering request for the user data.

In this way, in the system, even when an application is deleted so as to reserve resources, it is possible to save user data accompanying the application without consuming terminal resources.

In addition, the application managing apparatus of the present invention is applicable to resource-poor apparatuses such as network home appliances, home gateways, video telephone terminals, and video games, as well as STB.

Further, it may be possible to achieve any one of Embodiments 1 to 5 as software. For example, a program for managing start-up and install of applications may be stored in ROM in advance to be operated with CPU. Furthermore, it may be possible to store a program for managing start-up and install of applications in a computer readable storage medium, further store the program stored in the storage medium in RAM of a computer, and to operate the computer according to the program. Such cases also have the same functions and effects as in Embodiments 1 to 5.

Moreover, it may be possible to store a program for managing start-up and install of applications in a server, transmit the program stored in the server to a client corresponding to a request from the client, and to execute the program on the client. Further, it may be possible to store a program for managing start-up and install of applications in a server, and to execute the program on the server corresponding to a request from the client.

As is apparent from the foregoing, the application managing apparatus of the present invention is capable of performing efficient application start-up management and install management with the resource consumption of apparatuses and increases in the overhead both suppressed.

In this apparatus, since resident applications are started as many as the resources permit, it is possible to response to a request from a client promptly.

Further, since an application is installed corresponding to a request, it is possible to save a disk space required for storing applications.

Furthermore, in the system enabling a server to control the operation of the application managing apparatus, it is possible to adapt a status of an application before a request from a client, and it is thereby possible to response to the request from the client promptly.

Still furthermore, it is possible to prevent occurrences of the double billing and losing of user data both of which may take place in deleting an application to use resources.

The present invention is not limited to the above described embodiments, and various variations and modifications may be possible without departing from the scope of the present invention.

This application is based on the Japanese Patent Application No. 2001-160802 filed on May 29, 2001, entire content of which is expressly incorporated by reference herein.

What is claimed is:

1. An application managing apparatus comprising:
receiving means for receiving a connection request for connecting to an application;
obtaining means for obtaining a currently usable resource amount when the application targeted for the connection request is not started; and
starting means for starting the application targeted for the connection request while keeping a currently accept-state application (keeping an already started application in its accept state), when an obtained resource amount is more than a resource amount needed for executing the application targeted for the connection request.

2. An application managing apparatus comprising:
receiving means for receiving a connection request for connecting to an application;
obtaining means for obtaining a currently usable resource amount when the application targeted for the connection request is not started; and
determining means for determining an application to stop among currently accept-state applications (already started applications), when an obtained resource amount is less than a resource amount needed for executing the application targeted for the connection request.

3. The application managing apparatus according to claim 2, further comprising:
managing means for managing operation logs of the currently accept-state applications,
wherein said determining means determines an application to stop based on a result of analyzing the operation logs.

4. The application managing apparatus according to claim 3, wherein said managing means manages, as the operation logs, transaction states of the currently accept-state applications, and said determining means determines an application with an earliest time of finishing transaction to be the application to stop.

5. The application managing apparatus according to claim 3, wherein said managing means manages, as the operation logs, processing requested for applications, and said determining means determines an application with a least number of times processing therefor is requested to be the application to stop.

6. The application managing apparatus according to claim 2, wherein said determining means determines the application to stop so as to minimize the number of applications to be stopped to reserve a resource amount needed for starting the application targeted for the connection request.

7. An application managing apparatus comprising:
receiving means for receiving a connection request for connecting to an application;
obtaining means for obtaining a free space of storage means when an application targeted for the connection request is not installed onto said storage means; and
determining means for determining an application to uninstall among applications currently installed onto said storage means, when an obtained free space is less than a volume of the application targeted for the connection request.

8. The application managing apparatus according to claim 7, further comprising:
managing means for managing operation logs of the applications currently installed onto said storage means, wherein said determining means determines an application to uninstall based on a result of analyzing the operation logs.

9. The application managing apparatus according to claim 8, wherein said managing means manages, as the operation logs, stopped times of the applications currently installed onto said storage means, and said determining means determines an application with a longest stopped time to be the application to uninstall.

10. The application managing apparatus according to claim 7, further comprising:
saving means for saving user data accompanying the application to uninstall in a server, wherein the application managing apparatus is connected to said server through a network.

11. The application managing apparatus according to claim 10, wherein said saving means receives the user data saved in said server when the application to uninstall is uninstalled and then installed again.

12. An application managing apparatus connected through a network to a server that controls start-up and install of an application, said application managing apparatus comprising:
means for providing a start-up status or an install status of an application to said server through the network;
receiving means for receiving a start-up request or an install request issued by said server based on the start-up status or the install status, respectively; and
means for starting or installing the application according to the start-up request or the install request, respectively.

13. A server connected through a network to an application managing apparatus that manages start-up and install of an application, said server comprising:
obtaining means for obtaining a start-up status or an install status of an application provided from said application managing apparatus; and
means for issuing a start-up request or an install request to said application managing apparatus based on the start-up status or the install status, respectively.

14. A server that bills a terminal apparatus when said terminal apparatus downloads an application from said server through a network, said terminal apparatus provided with an application managing apparatus that manages install of an application, said server comprising:
means for authenticating a terminal apparatus that downloads an application; and
means for managing a correspondence between an authenticated terminal apparatus and an application that said authenticated terminal apparatus downloads, wherein said server does not bill said authenticated terminal apparatus for an application that said authenticated terminal apparatus previously downloaded.

15. An application managing program comprising:
a receiving step of receiving a connection request for connecting to an application;
an obtaining step of obtaining a currently usable resource amount when the application targeted for the connection request is not started; and
a starting step of starting the application targeted for the connection request while keeping a currently accept-state application (keeping an already started application in its accept state), when an obtained resource amount is more than a resource amount needed for executing the application targeted for the connection request.

16. An application managing program comprising:
a receiving step of receiving a connection request for connecting to an application;
an obtaining step of obtaining a currently usable resource amount when the application targeted for the connection request is not started; and
a determining step of determining an application to stop among currently accept-state applications, when an obtained resource amount is less than a resource amount needed for executing the application targeted for the connection request.

17. An application managing program comprising:
a receiving step of receiving a connection request for connecting to an application;
an obtaining step of obtaining a free space of storage means when an application targeted for the connection request is not installed onto said storage means; and
a determining step of determining an application to uninstall among applications currently installed onto said storage means, when an obtained free space is less than a volume of the application targeted for the connection request.
